(19) United States
(12) Patent Application Publication
(10) Pub. No.: US 2026/0161359 A1
(43) Pub. Date: Jun. 11, 2026

(54) HARDWARE ACCELERATORS FOR DOT-PRODUCT BASED LOOKUP ALGORITHMS INCLUDING HARDWARE ACCELERATORS FOR TRANSFORMER KEY-VALUE CACHES

(71) Applicant: OpenAI OpCo, LLC., San Francisco, CA (US)

(72) Inventors: Clive Chan, San Francisco, CA (US); Chian-min RIchard Ho, Palto Alto, CA (US); Ravi Narayanaswami, San Jose, CA (US); Kaushik Vaidyanathan, San Francisco, CA (US)

(73) Assignee: OpenAI OpCo, LLC., San Francisco, CA (US)

(21) Appl. No.: 18/971,870

(22) Filed: Dec. 6, 2024

(51) Int. Cl. G06F 7/57

(52) U.S. Cl. CPC G06F 7/57

(57) ABSTRACT

A hardware accelerator is provided for dot-product based lookup algorithms including hardware accelerators for transformer key-value. The accelerator includes memory stacks that include memory banks (e.g., DRAM) fabricated on respective memory dies. The memory banks can be connected by through silicon vias (TSVs). The accelerator also includes arithmetic logic units configured on a processor die, and that include dedicated circuitry for the dot-product based lookup algorithm. The processor die can be arranged below the memory stacks to minimize the wire lengths from the ALUs to the memory stacks to reduce energy consumption due to moving bits between the ALUs and the memory stacks. The length of the wires from the ALUs to the memory stacks can be less than 1 mm (e.g., as short as 0.05 mm). The accelerators can also include processing in memory ALUs that include dedicated circuitry for the dot-product based lookup algorithm

### BACKGROUND

General computing tasks can be efficiently performed using a central processing unit (CPU) that uses electronic circuitry to execute instructions of a computer program, such as arithmetic, logic, controlling, and input/output (I/O) operations. The CPU is not optimized for any one particular computing task. Specialized computing tasks can be offloaded to specialized circuitry optimized for that specialized computing task. For example, graphics processing tasks can be offloaded to specialized coprocessors such as graphics processing units (GPUs).

This specialized circuitry provides hardware acceleration by using computer hardware designed to perform specific functions making it more efficient compared to software running on a general-purpose CPU. In addition to GPUs, other examples of hardware acceleration include data processing units (DPUs), neural processing units (NPUs), etc.

To perform computing tasks more efficiently, one can invest time and money in improving the software, improving the hardware, or both. The advantages of focusing on hardware may include speedup, reduced power consumption, lower latency, increased parallelism and bandwidth, and better utilization of area and functional components available on an integrated circuit; at the cost of decreased ability to update designs once etched onto silicon higher costs of functional verification, increased time to market, and the need for more parts. In the hierarchy of digital computing systems ranging from general-purpose processors to fully customized hardware, there is a tradeoff between flexibility and efficiency.

Examples of hardware acceleration include: (1) Graphics Processing Units (GPUs); (2) Field-Programmable Gate Arrays (FPGAs); (3) Application-Specific Integrated Circuits (ASICs); and (4) Digital Signal Processors (DSPs). GPUs can include hundreds or thousands of cores, allowing them to perform many calculations simultaneously, making them ideal for tasks like rendering graphics and training deep learning models. GPUs are widely applicable and can be used in gaming, scientific simulations, and machine learning. FPGAs can be programmed to perform specific tasks very efficiently, providing flexibility for various applications, from signal processing to machine learning inference. FPGAs provide low latency, making them well-suited for real-time applications where speed is critical. As the name implies, ASICs can be designed for a specific application, such as Bitcoin mining or neural network processing. ASICs can outperform general-purpose hardware in their designated tasks. Further, ASICs provide improved efficiency because they consume less power and deliver higher performance than FPGAs or CPUs for their specific use cases. DSPs are specialized for processing signals in real-time, such as audio and video processing, and are used in devices like smartphones and audio equipment.

Some, but not all, artificial intelligence (AI) and machine learning (ML) tasks can be performed more efficiently using existing hardware accelerators as opposed to using CPUs. For example, training and inference of deep learning models benefit greatly from GPU and TPU (Tensor Processing Unit) acceleration, significantly reducing training times and enabling real-time predictions.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a prior art example of communicating between high bandwidth memory (HBM) and a processor.

FIG. 2A illustrates a block diagram of an example of a key value (KV) cache accelerator, in accordance with certain embodiments.

FIG. 2B illustrates another block diagram of an example of a KV cache accelerator, in accordance with certain embodiments.

FIG. 3A illustrates a block diagram for an example of a transformer neural network architecture, in accordance with certain embodiments.

FIG. 3B illustrates a block diagram for an example of an encoder of the transformer neural network architecture, in accordance with certain embodiments.

FIG. 3C illustrates a block diagram for an example of a decoder of the transformer neural network architecture, in accordance with certain embodiments.

FIG. 4A illustrates a block diagram for an example of a multi-head attention block, in accordance with certain embodiments.

FIG. 4B illustrates a block diagram for an example of a scaled dot-product block, in accordance with certain embodiments.

FIG. 5A illustrates a block diagram for an example of an arithmetic logic unit, in accordance with certain embodiments.

FIG. 5B illustrates a block diagram for another example of an arithmetic logic unit, in accordance with certain embodiments.

FIG. 6 illustrates a block diagram for another example of a MatMul accelerator, in accordance with certain embodiments.

FIG. 7A illustrates an example of a scaled dot-product attention accelerator, in accordance with certain embodiments.

FIG. 7B illustrates an example of a multi-head attention accelerator, in accordance with certain embodiments.

FIG. 8A illustrates an example of packaging KV cache accelerators on a PCIe card, in accordance with certain embodiments.

FIG. 8B illustrates an example of packaging KV cache accelerators in a dense packaging configuration, in accordance with certain embodiments.

FIG. 8C illustrates a first example of how KV cache accelerators can be connected in a system, in accordance with certain embodiments.

FIG. 8D illustrates a second example of how KV cache accelerators can be connected in a system, in accordance with certain embodiments.

FIG. 8E illustrates a third example of how KV cache accelerators can be connected in a system, in accordance with certain embodiments.

FIG. 9 illustrates an example of arranging components of a KV cache accelerator with the processor die near a thermal removal member to improve thermal management, in accordance with certain embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

The disclosed technology addresses the need in the art for hardware accelerators for dot-product based lookup algorithms, such as hardware accelerators for transformer key-value (KV) caches.

For example, large Transformer models are the main workload of interest for artificial intelligence (AI) in the year 2024. These models increasingly use longer contexts to consume and process information, and GPUs are poorly adapted to the task of attention inference because of the enormous amount of state (e.g., KV cache) that is accessed for every token generated by the model.

The bottleneck for operations such as attention mechanisms in transformers is the high ratio of data transfers relative to arithmetic/logical operations. For example, the attention mechanism in transformers has low arithmetic intensity (e.g., low double digits of flops to memory bandwidth) compared to the flops-to-memory-bandwidth ratio of datacenter AI accelerators (e.g., existing accelerators optimally perform with a ratio of high triple-digit flops to memory bandwidth). Thus, memory bandwidth remains the limiting factor for multi-head attention calculations, even when using hardware acceleration, and the hardware roofline is not close to being achieved. Additionally, for existing hardware accelerators, when performing attention mechanism computation, the energy consumption is dominated by data movement rather than computations.

To address these challenges for existing hardware accelerators, a new hardware accelerator architecture is used with arithmetic logic units (ALUs) placed much closer to the high bandwidth memory (HBM). For example, ALUs that are specifically configured to perform matrix multiplications can be placed in a processor die immediately below memory bank stacks of the HBM. Additionally, processing in memory (PIM) ALUs can be used to perform some of the arithmetic operations of the transformer attention computations, and the remaining arithmetic operations of the transformer attention computations can be performed by the ALUs fabricated on the processing die. By decreasing the distance between the ALUs and the HBM, the energy loss due to moving bits to and from HBM can be significantly reduced. Further, the ratio between the memory bandwidth and the compute can be improved by using dedicated circuitry in the ALUs that is specialized for the given task (e.g., the computations used in the transformer attention computations, such as the query-key (QK) dot products and the PV weighted sum calculations).

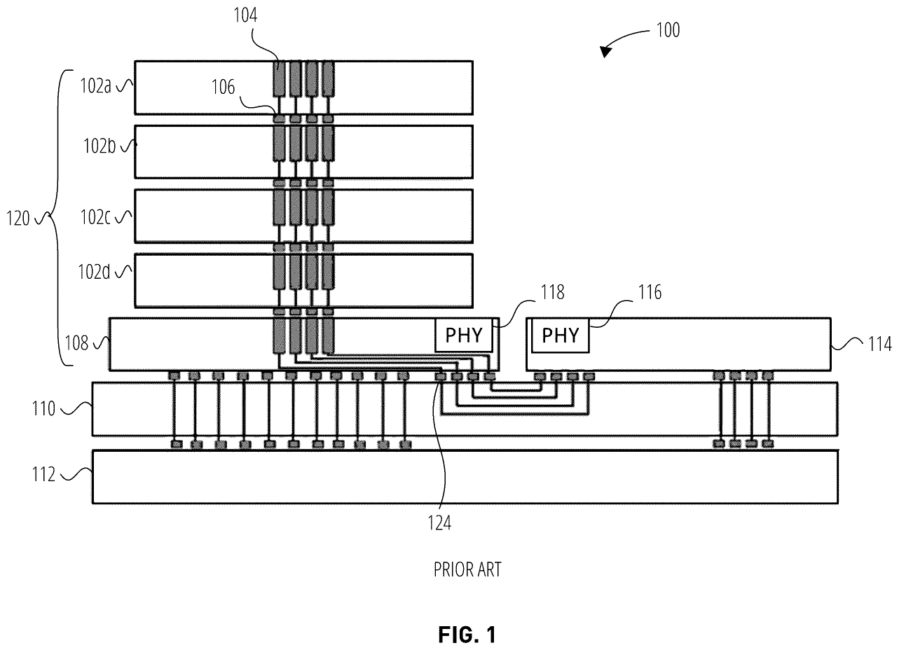

FIG. 1 illustrates an example of the prior art in which interposer 110 is arranged on Package substrate 112 to provide electrical paths between a high bandwidth memory stack (e.g., HBM stack 120) and processor die 114. HBM stack 120 includes a stack of HBM DRAM dies (e.g., HBM DRAM die 102a, HBM DRAM die 102b, HBM DRAM die 102c, and HBM DRAM die 102d) arranged and logic die 108. The number of HBM DRAM dies in HBM stack 120 can be eight, for example. The logic die 108 includes HBM PHY 118 that provides communication with other chiplets/dies, such as communications with processor PHY 116 of processor die 114. Processor die 114 can be a GPU, a CPU, or a system on a chip, for example. The HBM DRAM dies are connected to interposer 110 by a series of through silicon vias (e.g., TSV 104), connection bumps 124, and wire pathways through logic die 108. The wire pathways are electrical pathways that can include a combination of metal-layer traces, through-silicon vias, and passive and/or active circuitry (e.g., buffer circuits). The wire pathways can transmit bits between a respective arithmetic logic unit and the associated/corresponding memory stack.

A challenge of the configuration illustrated in FIG. 1 is that the loss through the wires (e.g., ohmic loss, radiative loss, dielectric loss, and power consumed by active components such as buffer circuits) can be relative to (e.g., proportional to) the length of the wires. In applications that require frequent bit transfers between memory and the processors, the losses due to transmitting bits can be the dominant source of energy consumption in the system. For example, in the configuration illustrated in FIG. 1, the loss due to transferring 32 bits can be about 16 pJ, whereas only 0.15 pJ is consumed for a 32-bit floating point operation (FLOP). The exact energy consumption per FLOP can depend on the type of FLOP (e.g., addition or multiplication) and on the specification of the processor (e.g., voltage and transistor size). Additionally, data communications through the physical layers (e.g., PHY) introduce latency and additional energy consumption. Improving energy efficiency is important in its own right, but it is also important for thermal management because the consumed energy is converted to heat that must be transferred from the system to maintain proper functioning.

The loss through the wires can be proportional to the length of the wires from die to die, which is about 5 mm or greater when using the configuration in FIG. 1, due to the dimensions of the chiplets. For example, the minimum wire length from the HBM DRAM dies to processor die 114 is dictated by the chiplet sizes. For example, HBM1 packages can have dimensions of 5.5 mm×7.3 mm×0.5 mm (W×L×H). Similarly, HBM2 packages can have dimensions of 7.8 mm×11.9 mm×0.7 mm. For processor chiplets, the (W×L) dimensions can range between (5 mm×5 mm) to (30 mm×30 mm). Accordingly, typical wire lengths from the HBM to the processor can range between 5 mm to about 30 mm.

The configuration illustrated in FIG. 1 performs well for many computational tasks, such as those in which the ratio of computations to memory usage is large (e.g., a triple-digit or quadruple-digit ratio for floating-point operations (flops) to memory bandwidth usage). But as discussed below, alternative configurations can provide improved performance for other computational tasks, such as those with smaller ratios of computations to memory usage (e.g., a double-digit ratio of flops to memory bandwidth usage). Multi-head attention processing is one example of a computation task that uses large amounts of memory and frequent memory reads relative to the logic and/or arithmetic processing.

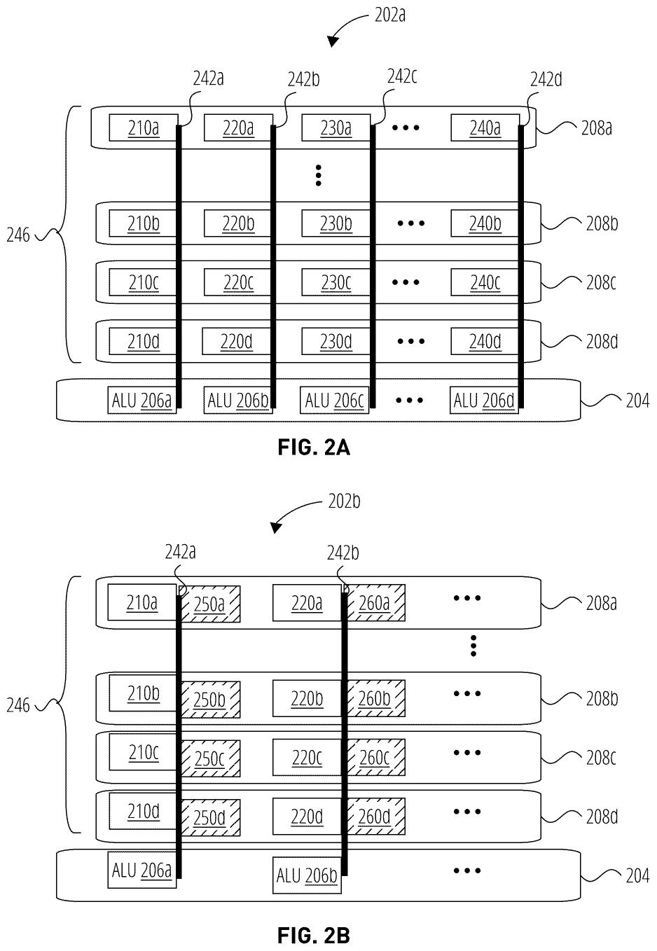

FIG. 2A and FIG. 2B illustrate two examples of alternative configurations that can provide improved performance for certain computational tasks, such as multi-head attention blocks for transformer neural networks. System 202a and system 202b can be used as hardware accelerators for various applications and are not limited to being hardware accelerators for attention operations used in transformer ML models. However, in this disclosure, systems 202a and system 202b will generally be described using non-limiting examples of KV cache accelerators, which provide cache memory (e.g., for key K and value V matrices) close to the arithmetic logic units (ALUs). Therefore, systems 202a and system 202b will generally be referred to herein as KV cache accelerator architectures but are not limited to being used for KV cache accelerators.

Large transformer models are the main workload of interest for AI in 2024. These models increasingly use longer context, resulting in increased consumption and processing of information for a given task. Other hardware accelerators, such as GPUs, are inadequately adapted to the task of attention inference due to the use of an enormous amount of state (e.g., keys and values (KV) cache) that is accessed for every token generated by the model.

Some approaches to address this challenge focus on modifying the algorithms to decrease the amount of state used to generate each token. For example, many model architecture innovations such as Multi-Query Attention have reduced the amount of state that is accessed for every token at runtime. Even with changes to the algorithms, a bottleneck remains for operations such as attention mechanism in transformers, which have a higher ratio of data transfers relative to arithmetic or logical operations. For example, the attention mechanism in transformers has low arithmetic intensity (e.g., low double digits of flops to memory bandwidth, such as but not limited to 10:1) compared to the flops-to-memory-bandwidth ratio of datacenter AI accelerators (e.g., high triple-digits of flops to memory bandwidth, such as but not limited to 800:1). Thus, memory bandwidth remains the limiting factor for multi-head attention calculations, even when using hardware acceleration, and the hardware roofline is not close to being achieved.

Further, as discussed above, the energy of operation is dominated by data movement rather than computations. Assuming that the loss due to transferring 1 bit is about 0.5 pJ and the energy consumed per 32-bit FLOP is 0.15 pJ, a 10:1 ratio for flops to memory bandwidth would result in 16 pJ consumed due to transferring data from memory and only 1.5 pJ consumed due to calculations. Even if the flops-to-memory-bandwidth ratio was 50:1, the energy consumed due to transferring bits is still more than twice the energy consumed by the computations.

FIG. 2A addresses this challenge by significantly shortening the wire length. As discussed above, the height of an HBM chiplets can be about 0.5 mm to about 0.7 mm. The thickness of the DRAM dies can be about 30 μm, and the micro bumps, which are used to electrically connect one DRAM die to the next DRAM die, can be about 25 μm in diameter, resulting in an eight-high HBM die stack height that is less than 0.5 mm, which is also the length of the electrical path through the TSVs and the micro bumps. Thus, the loss for transferring bits in system 202a can be about 10 times less than for system 100, assuming the same or similar dimensions for the wire cross-sections in both systems. According to certain non-limiting examples, the shorter transmission distances can eliminate the need for a physical layer (PHY) that is used for the longer transmission distances and different protocols used in die-to-die communications.

In FIG. 2A, HBM stack 246 includes HBM DRAM dies 208a, 208b, 208c, and 208d, and each of the HBM DRAM dies includes a series of memory banks. For example, HBM DRAM die 208a includes memory banks 210a, 210b, 210c, and 210d, which are connected to ALU 206a by TSV 242a; HBM DRAM die 208b includes memory banks 220a, 220b, 220c, and 220d, which are connected to ALU 206b by TSV 242b; HBM DRAM die 208c includes memory banks 230a, 230b, 230c, and 230d, which are connected to ALU 206c by TSV 242c; and HBM DRAM die 208d includes memory banks 240a, 240b, 240c, and 240d, which are connected to ALU 206d by TSV 242d. Often the array of memory banks within a given HBM DRAM die is a two-dimensional array. FIG. 2A is, however, limited to illustrating a cross-section of system 202a.

According to certain non-limiting examples, banks of DRAM memory can be aligned in the vertical direction (memory banks 210a, 210b, 210c, and 210d), and TSVs 242a enable each bank of the vertical stack to move bits to and from the connected arithmetic logic unit (ALU). The ALU can include various logic gates (e.g., AND gates, XOR gates, NOT gates, etc.), shift registers, clocks, and other logic gates for performing logical and arithmetic operations (e.g., integer and/or floating-point addition and multiplication).

According to certain non-limiting examples, the ALUs perform arithmetic and logical operations, such as integer and floating-point arithmetic, enabling the processor to execute a wide variety of calculations. The ALU receives input operands (data) from registers or memory at the input ports for the operands (e.g., a Q value and a K value for performing a dot-product calculation). For example, the ALU can have two input ports (e.g., input “A” and input “B” for the operands (e.g., the addition operation “+”), and output a single value resulting from the aopperation (e.g., output “A+B”). The control unit directs the ALU to perform specific operations based on control signals provided to an instruction decoder. The result of the operation is sent back to registers or memory through an output port. Integer arithmetic can include integer addition and multiplication. In addition (and subtraction), a combination of XOR gates and AND gates (for the carry bits) combine two integers to produce a sum. In multiplication (and division), a combination of bit shifts and AND gates can be used to calculate the product of two integers. Additionally, the ALU can perform floating-point arithmetic. Floating-point arithmetic is more complex than integer arithmetic due to the representation of numbers in scientific notation. For example, addition and subtraction involve aligning the exponents, adding or subtracting the significands, and normalizing the result. Multiplication (division) includes multiplying (dividing) the significands and adding (subtracting) the exponents.

The ALUs in 202a can be specialized to stream operations for a particular ML block, such as multi-head attention 322. Although system 202a is illustrated using the non-limiting example of multi-head attention, system 202a can also be used for other applications that similarly use a high amount of memory bandwidth relative to the number of arithmetic and logical operations. In each case, the ALUs can be optimized for the particular application in which they are being used as a hardware accelerator.

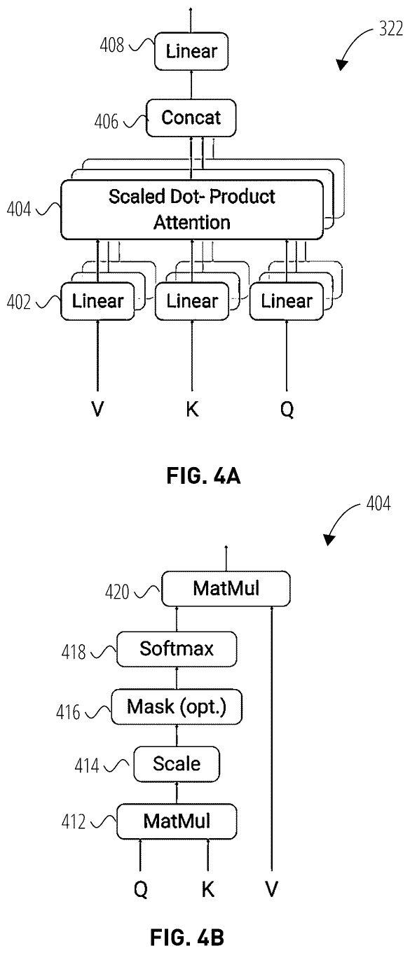

As discussed above, system 202a can provide performance improvements for multi-head attention blocks used in transformer neural networks. When used in multi-head attention blocks, the configuration in system 202a can provide rapid, reduced energy KV cache lookups for transformers in which a query is broadcast against a set of keys and values, as discussed herein with respect to FIG. 4A and FIG. 4B. In addition to providing KV cache lookups, system 202a can provide improved performance for many related dot-product based lookup algorithms, which encounter similar challenges to those discussed above. For example, in Batch 1 model inference, a feature vector is sent instead of a query, and the feature vector is broadcast against a stored weight matrix. Additionally, in algorithms using feature stores or vector embedding databases, dot-product lookups can be performed across a very large number of vectors to return the top K results wherein K is a predefined integer defining the number of results to return. As additional examples of models that benefit from system 202a, Mamba, Receptance Weighted Key Value (RWKV), Retrieval Transformer, and other alternatives or modifications of transformer neural networks can also store state (similar to K and V values) and do lookups via a dot-product mechanism.

Consider the non-limiting example in which system 202a is configured to perform a scaled dot-product. The scaled dot-product is discussed below with reference to FIG. 4B. The query “Q” can be a vector of length M, and the state can be represented by keys “K” and values “V, which respectively have dimensions N×M and N×L. System 202a can receive a query including the Q, K, and V matrices, which are stored in the HBM stack 246. The ALUs then stream in parallel the dot products for Q·K^{T}, and the result (first result) can be stored in HBM stack 246 and then recalled from memory when the ALUs perform scaling or the first result can be fed directly into another portion of the ALU that performs scaling by dividing the first result by the square root \sqrt{M}, generating a scaled result Z. The ALU then applies a SoftMax to the scaled result, generating a SoftMax output. Depending on how the ALUs are configured, the calculations of the dot products for Q·K^{T}, scaling, and the SoftMax operations can be performed in consecutive parts of the ALU without storing the results in HBM stack 246 until the SoftMax result, or the ALU can store intermediate results of the operations (e.g., the first result and the scaled result) in HBM stack 246 before proceeding to the next operation. According to certain non-limiting examples, the SoftMax operation can be calculated as

$${p}_{i} = \frac{exp ( {z}_{i} )}{{\sum }_{n = 1}^{N} exp ( {z}_{n} )}$$

wherein pᵢ is the i^{th} SoftMax result and zᵢ is the i^{th} scaled result. The normalization

$${\sum }_{n = 1}^{N} exp ( {z}_{n} )$$

depends on all the scaled results being computed. The SoftMax results P can be stored in HBM stack 246, and the ALUs can stream the calculations for the P V weighted sums (e.g., the dot product for P·V) with the output being returned to the source of the request (e.g., the CPU or GPU that requested the attention accelerator in system 202a to perform the scaled dot-product attention).

According to certain non-limiting examples, a first accelerator portion of the ALUs is used to stream in parallel the dot products for Q·K^{T} together with the scaling operations and then store the scaled results Z in HBM stack 246. Next, the ALUs perform the SoftMax operation on the scaled results Z to generate the SoftMax result P, and a second accelerator portion of the ALUs is used to stream the calculations for the P V weighted sums, generating the output O=P·V.

FIG. 2B illustrates system 202b, which can be an alternative to system 202a. In system 202b, HBM stack 246 includes additional ALUs that are fabricated on the HBM DRAM dies. The additional ALUs on the HBM DRAM dies can be referred to as processing in memory (PIM) ALUs. Each memory bank on an HBM DRAM die can be associated with a corresponding PIM ALU. For example, a first stack of memory banks can include memory bank 210a associated with PIM ALU 250a, memory bank 210b associated with PIM ALU 250b, memory bank 210c associated with PIM ALU 250c, and memory bank 210d associated with PIM ALU 250d. Further, the first stack of memory banks can be connected to each other and to ALU 206a using TSV 242a.

Relatedly, a second stack of memory banks can include memory bank 220a associated with PIM ALU 260a, memory bank 220b associated with PIM ALU 260b, memory bank 220c associated with PIM ALU 260c, and memory bank 220d associated with PIM ALU 260d. Further, the second stack of memory banks can be connected to each other and to ALU 206a using TSV 242b.

When the operations requiring high memory bandwidth (e.g., the matrix multiplications used for calculating Q·K^{T} and P·V) are performed using the PIM ALUs, the ALUs fabricated on processor die 204 can be used for more computationally intensive operations that use less memory bandwidth. For example, the SoftMax operation is a more computationally intensive operation that use less memory bandwidth than the scaled dot-product operations. The SoftMax operation can use exponential calculations which can be more computationally intensive using Taylor's series expansions and look up tables to approximate the exponential as a polynomial that can be calculated using the standard multiplication and addition operations.

ALUs fabricated on processor die 204 can be fabricated using silicon manufacturing processes that are optimized for arithmetic and logical operations, enabling the ALUs fabricated on processor die 204 to outperform the PIM ALUs, which are fabricated using silicon manufacturing processes that are optimized for dense memory rather than efficient logic. However, the PIM ALUs have very short distances between the memory bank and the ALU making them ideal for tasks requiring high memory bandwidth and less computations. Thus, system 202b is well suited to a division of labor among the different types of ALUs, where each type of ALU is applied to perform operations consistent with its relative advantages (e.g., high memory bandwidth, low compute operations on the PIM ALUs and low memory bandwidth, high compute operations on the processor-die ALUs).

Because the process-die ALUs are used for less memory bandwidth intensive operations, the ALUs can be spaced farther from the memory bank stack. For example, when only low memory bandwidth operations are performed on the process-die ALUs, the decrease in performance experienced by moving the processor-die ALUs (e.g., ALU 206a and ALU 206b) farther away from the memory bank stack (e.g., by moving the processor-die ALUs to a processor die that is adjacent to HBM stack 246, as illustrated in FIG. 1) might not be significant. For example, according to certain non-limiting examples, ALU 206a in system 202b can be spaced from HBM stack 246 by an interposer or other circuitry without suffering too dramatic of a decrease in performance, depending on the application for which the hardware acceleration is to be used.

According to certain non-limiting examples, system 202b can be configured as a hardware accelerator to perform transformer attention operations. System 202b can include instructions and/or specialized circuitry in the PIM ALUs to stream the dot products for Q·K^{T}. System 202b can include instructions and/or specialized circuitry to perform the scaling operation and the SoftMax operation. The products for Q·K^{T} can access (N+1)×M values from memory, whereas the scaling operation and the SoftMax operation each only access N values from memory. System 202b can further include instructions and/or specialized circuitry in the PIM ALUs to stream the PV weighted sums for P·V.

As discussed above, math circuits manufactured in processor dies can be more inefficient than math circuits that are manufactured in PIM memory dies because memory dies are fabricated using silicon manufacturing processes that are optimized for dense memory rather than for efficient logic. For this reason, system 202b includes ALUs on processor die 204, which are fabricated using manufacturing processes that are optimized for math and logical operations.

Additionally, a higher-level accelerator (e.g., a CPU or GPU) can perform a larger block of an AI model, and the higher-level accelerator can offload the attention operations to system 202b, which functions as a hardware accelerator for just the attention operations. For example, the higher-level accelerator can be performing an encode block 310 or a decode block 314, and the higher-level accelerator acts as a requester that offloads multi-head attention block 322 to system 202b by sending a request to system 202b that includes the Q, K, and V data and instructions to perform the attention operations. Upon completion of the request, system 202b returns the output (e.g., attention logits) back to the higher-level accelerator. Processor die 204 can also include circuitry to send the attention logits back to the requester (e.g., ALU 206a or other communications circuitry, such as a physical layer PHY on processor die 204). According to certain non-limiting examples, processor die 204 includes the functionality to handle broadcasts and/or reductions. That is, processor die 204 can include circuitry with the specific functionality for broadcasting queries across ALUs, computing SoftMax, and/or reducing the final attention output, such that HBM stack 246 and the PIM-ALU are not required to perform these functionalities.

As discussed above, PIM ALUs have the advantage of the high-bandwidth path arising from keeping the data on the die.

The benefits provided by the KV cache architectures as exemplified by system 202a and system 202b depends on the dimensions of Q, K, and V data. As discussed above, the query “Q” can be a vector of length M, and the state can be represented by keys “K” and values “V, which respectively have dimensions N×M and N×L. In transformer models like GPT, the dimensions of the Key and Value matrices depend on the model's architecture, specifically the size of the hidden states and the number of attention heads.

Consider for example the transformer GPT-2, the length of Q can be 1024. More recent models allow for lengths greater than 1024 (e.g., 2048). The hidden size (or embedding dimension) of the model can be represented as d. For example, in GPT-2, d might be 768 or 1024, depending on the model variant. The model typically uses multiple attention heads, denoted as h. For instance, GPT-2 often uses 12 or 16 heads. The dimension of the Key and Value vectors for each attention head is dₖ, where dₖ=d/h. For example, if d=768 and h=12, then dₖ would be 64. The Key matrix K can have dimensions d×n, and the Value matrix V also has dimensions d×n. For newer GPT models than GPT-2, n can be larger to provide improved predictions by the GPT models, and n can be much greater than 1028 (e.g., n can be 16,448 or greater).

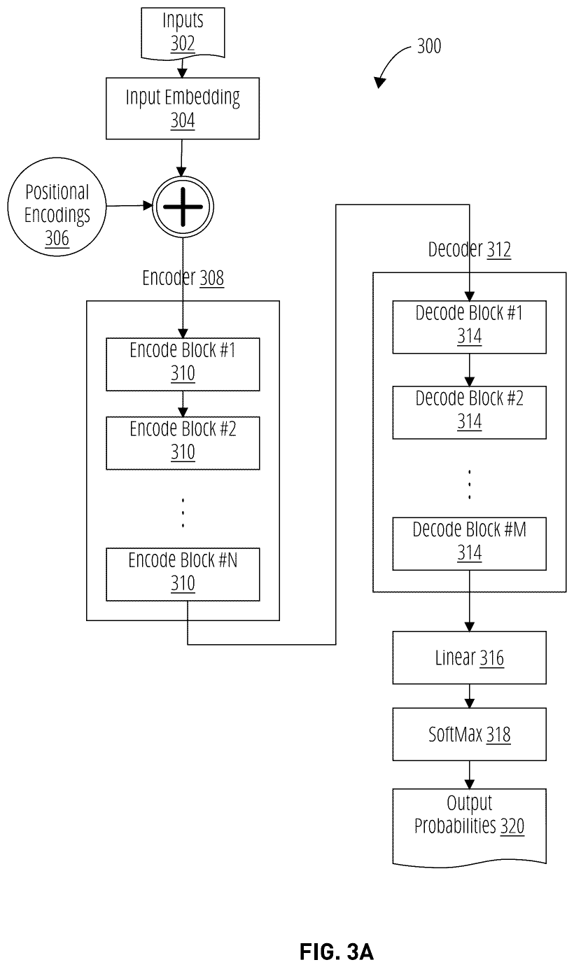

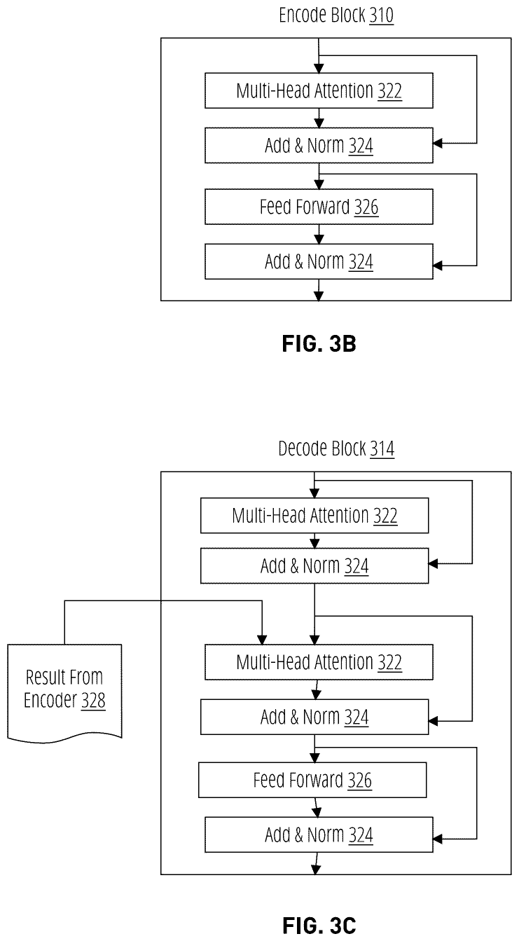

As discussed above, by moving the ALUs closer to the HBM performance of KV cache accelerators such as system 202a and system 202b can be improved. As discussed above, the improvements provided by the disclosed KV cache accelerators can be beneficial in several applications such as, but not limited to, machine learning (ML) models that use multi-head attention computations (e.g., multi-head attention block 322) in a transformer architecture 300. FIG. 3A, FIG. 3B, and FIG. 3C illustrate transformer architecture 300 that uses multi-head attention blocks 322. A multi-head attention block in a transformer is a layer that uses multiple attention heads to find similarities and correlations between input elements. Each head is a set of Query, Key, and Value vectors that can focus on different parts of the input, capturing different aspects of word relationships.

For example, when applying a trained transformer architecture 300, the multi-head attention computations can include calculations of a scaled dot-product between vectors of query (Q), key (K), and value (V). The scaled dot-product can include matrix multiplication of Q and K, scaling the product, and a further matrix multiplication of the scaled product with V. For example, Q can be a vector of dimension “d,” whereas K and V can each be 100,000 vectors of dimension d. Thus, when system 202a and system 202b are used in an accelerator for multi-head attention block 322, the HBM DRAM in HBM stack 246 can be used to store the product of the matrix multiplication of Q and K, the scaled product, and the product of the matrix multiplication of the scaled product with V.

Examples of ML models that use a transformer neural network (e.g., transformer architecture 300) can include, e.g., generative pretrained transformer (GPT) models and Bidirectional Encoder Representations from Transformer (BERT) models. The transformer architecture 300, which is illustrated in FIG. 3A, FIG. 3B, and FIG. 3C, includes inputs 302, input embedding block 304, positional encodings 306, encoder 308 including encode blocks 310, decoder 312 including decode blocks 314, linear block 316, SoftMax block 318, and output probabilities 320.

Input embedding block 304 is used to provide representations for words. For example, embeddings can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 304 can be learned embeddings to convert the input tokens and output tokens to vectors of dimension have the same dimension as the positional encodings, for example.

Positional encodings 306 provide information about the relative or absolute position of the tokens in the sequence. According to certain non-limiting examples, positional encodings 306 can be provided by adding positional encodings to the input embeddings at the inputs to the encoder 308 and decoder 312. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 308 uses stacked self-attention and point-wise, fully connected layers. Encoder 308 can be a stack of N identical layers (e.g., N=6), and each layer can be an encode block, as illustrated by encode block 310 shown in FIG. 3B. Each encode block 310 has two sub-layers: (i) a first sub-layer has a multi-head attention block 322 and (ii) a second sub-layer has a feed forward block 326, which can be a position-wise fully connected feed-forward network. The feed forward block 326 can use a rectified linear unit (ReLU).

Encoder 308 uses a residual connection around each of the two sub-layers, followed by an add & norm block 324, which performs normalization. For example, the output of each sub-layer can be LayerNorm (x+Sublayer(x)). To facilitate these residual connections, all sub-layers in the model, as well as the embedding layers, produce output data having a same dimension.

Similar to encoder 308, decoder 312 uses stacked self-attention and point-wise, fully connected layers. Decoder 312 can also be a stack of M identical layers (e.g., M=6), and each layer can be a decode block, as illustrated by decoder 312 shown in FIG. 3B. In addition to the two sub-layers (i.e., the sublayer with multi-head attention block 322 and the sub-layer with feed forward block 326) found in encode block 310, decode block 314 can include a third sub-layer, which performs multi-head attention over the output of the encoder stack. In decode block 314, a second instance of multi-head attention block 322 receives as inputs the output from a first instance of add & norm block 324 and result 328 from encoder 308. Similar to encoder 308, decoder 312 uses residual connections around each of the sub-layers, followed by layer normalization. Additionally, the sub-layer with multi-head attention block 322 can be modified in the decoder stack to prevent positions from attending to subsequent positions. This masking, combined with the fact that the output embeddings are offset by one position, can ensure that the predictions for position i can depend only on the known output data at positions less than i.

Linear block 316 can be a learned linear transformation. For example, when transformer architecture 300 is being used to translate from a first language into a second language, linear block 316 can project the output from the last decode SoftMax block 318 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

SoftMax block 318 then turns the scores from linear block 316 into output probabilities 320 (which add up to 1.0). In each position, the index provides for the word with the highest probability, and then maps that index to the corresponding word in the vocabulary. Those words then form the output sequence of transformer architecture 300. The SoftMax operation is applied to the output from linear block 316 to convert the raw numbers into output probabilities 320 (e.g., token probabilities).

FIG. 4A illustrates an example of multi-head attention block 322. Each head receives V data, K data, and Q data. Each of these three sets of data is processed using a linear block 402 and the results are applied to scaled dot-product 404. The respective heads are concatenated using concatenation block 406, and the result is processed by another linear operation (e.g., linear block 402.

An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

FIG. 4B illustrates an example of scaled dot-product 404. Scaled dot-product 404 processes the query Q and the key K through a series of blocks including matrix multiplication 412, scaling operation 414, mask operation 416 (optional), and SoftMax operation 418 to generate a result, which is referred to herein as P. Matrix multiplication 420 processes P and the values V to generate a PV weighted sum as the output of scaled dot-product 404.

According to certain non-limiting examples, the input to scaled dot-product 404 includes queries and keys of dimension dₖ, and values of dimension dᵥ. The dot products of the query with all keys are computed and each result is divided by \sqrt{dₖ} before applying a SoftMax function to obtain the weights on the values.

For example, the attention function can be computed on a single query vector Q and the keys and values be packed together into matrices K and V to compute the matrix of outputs as:

$$Atention ( Q , K , V ) = softmax ( \frac{Q {K}^{T}}{\sqrt{{d}_{k}}} ) V .$$

Returning to FIG. 4A, multi-head attention can be performed using scaled dot-product 404. For example, instead of performing a single attention function with d_{model}-dimensional keys, values and queries, multi-head attention is performed by linearly projecting the queries, keys and values h times with different, learned linear projections to dₖ, dₖ and dᵥ dimensions, respectively. On each of these projected versions of queries, keys and values, the attention function can be performed in parallel, yielding dᵥ-dimensional output values. These are concatenated and once again projected, resulting in the final values, as depicted in FIG. 4A.

Multi-head attention allows the model to jointly attend to information from different representation subspaces at different positions. The result of the multi-head attention operation can be expressed as,

$$MultiHead ( Q , K , V ) = Concat ( {head}_{1} , … , {head}_{h} ) {W}^{O} , where$$

$${head}_{i} = Atention ( {QW}_{i}^{Q} , {KW}_{i}^{K} , {VW}_{i}^{K} ) ,$$

and the projections are parameter matrices

$${W}_{i}^{Q} ∈ {ℝ}^{{d}_{model} \times {d}_{k}} , {W}_{i}^{K} ∈ {ℝ}^{{d}_{model} \times {d}_{k}} , {W}_{i}^{V} ∈ {ℝ}^{{d}_{model} \times {d}_{k}} , and {W}_{i}^{O} ∈ {ℝ}^{{d}_{model} \times {d}_{k}} .$$

According to certain non-limiting examples, h=8 parallel attention layers or heads can be used, and for each head dₖ=dᵥ=d_{model}/h=64 can be used.

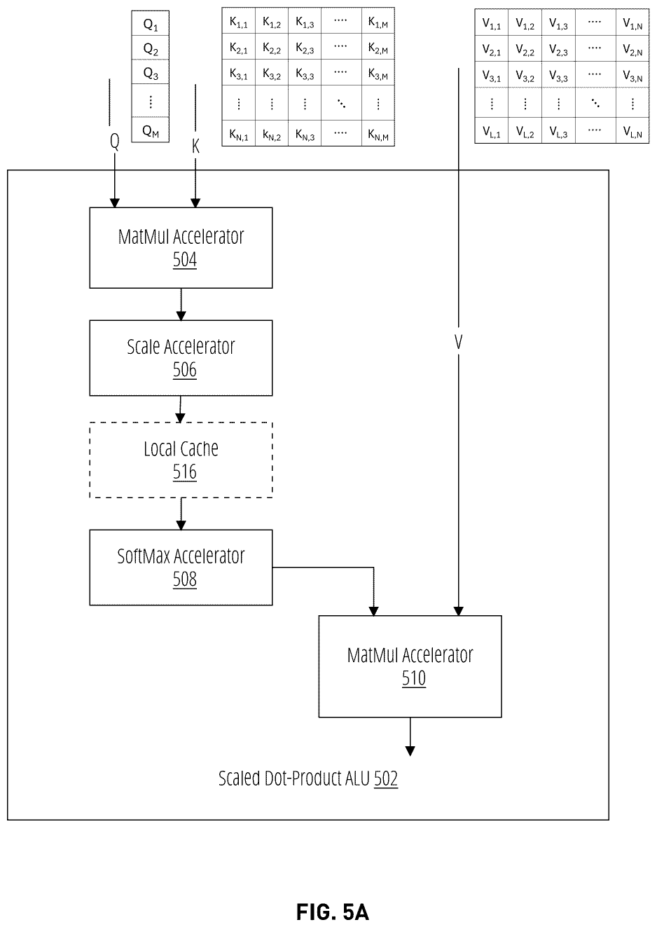

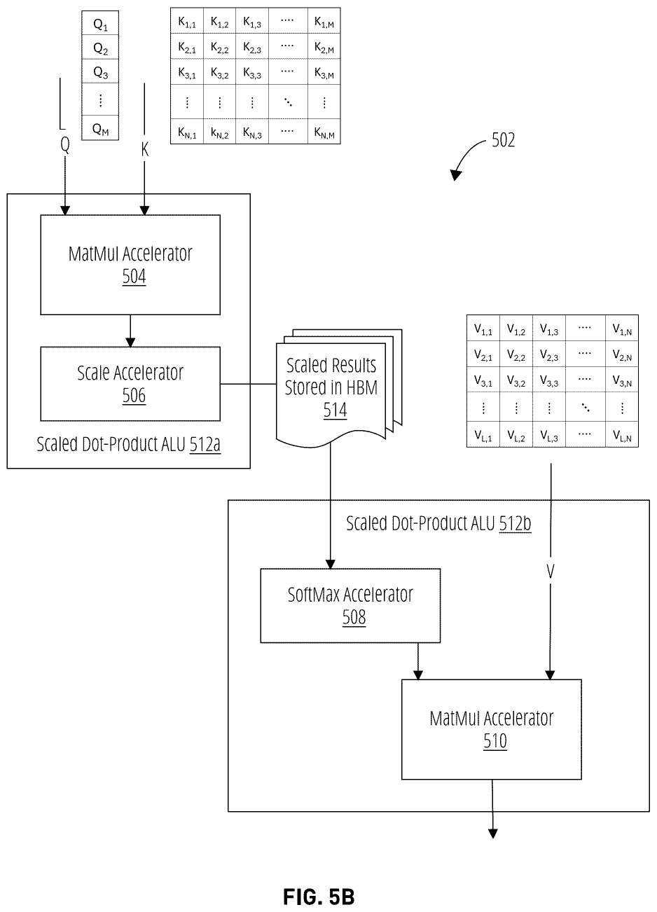

FIG. 5A illustrates an example of an ALU that includes specialized circuitry configured to accelerate a scaled dot-product operation. Scaled dot-product ALU 502 includes a matrix multiplication accelerator (e.g., MatMul accelerator 504), scaling accelerator 506, SoftMax accelerator 508, and another matrix multiplication accelerator (e.g., MatMul accelerator 510). MatMul accelerator 504 receives inputs Q (dimension M) and K (dimension N×M) and calculates the dot products QK^{T}, and the output from MatMul accelerator 504 feeds into scaling accelerator 506, which calculates the scaled result QK^{T}/\sqrt{dₖ}. The scaled result can be relatively small (e.g., dimension N) compared to the dimensions of K and V, such that the scaled result can be stored in either local cache 516 (optional) or in HBM stack 246.

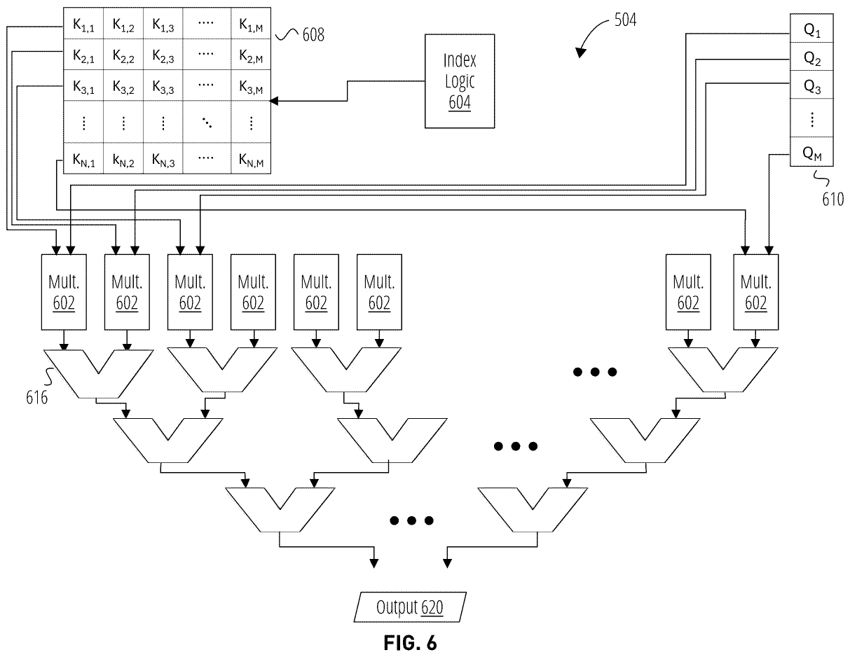

The scaled result from scaled dot-product ALUs 502 can feed into SoftMax accelerator 508, which generates a SoftMax result. The inputs to MatMul accelerator 510 are the SoftMax result and the V matrix. MatMul accelerator 504 and MatMul accelerator 510 can be implemented using a similar architecture. FIG. 6 illustrates an example of an architecture for a hardware accelerator implementing matrix multiplication.

Scale accelerator 506 can be implemented using parallel floating-point division logic to stream floating-point division on the outputs from MatMul accelerator 504.

SoftMax accelerator 508 can be implemented by first calculating exp (zᵢ) using parallel hardware accelerators for approximating exponentials using a lookup table for Taylor's series around discrete points nearest to the argument of the exponentials, and then using optimized hardware for calculating polynomials using floating-point multiplications followed by floating-point additions. The normalization

$${\sum }_{n = 1}^{N} exp ( {z}_{n} )$$

can be calculated using parallel floating-point additions, for example.

FIG. 5B shows another system architecture for hardware acceleration of the scaled dot-product using two ALUs (e.g., scaled dot-product ALU 512a and scaled dot-product ALU 512b). Scaled dot-product ALU 512a includes MatMul accelerator 504 and scale accelerator 506, and scaled dot-product ALU 512a writes the outputs from scale accelerator 506 to HBM stack 246 (e.g., the results are written to scaled results stored in HBM 514).

Scaled dot-product ALU 512b includes SoftMax accelerator 508 and MatMul accelerator 510. SoftMax accelerator 508 reads the scaled results from scaled results stored in HBM 514 and generates the SoftMax results. And the inputs to MatMul accelerator 510 are the SoftMax results and the V matrix. MatMul accelerator 504, scale accelerator 506, SoftMax accelerator 508, and MatMul accelerator 510 can be implemented as discussed above for FIG. 5A.

FIG. 6 illustrates an example of an implementation of MatMul accelerator 504. A similar hardware accelerator architecture can be used for MatMul accelerator 510. Index logic 604 controls which indices of query 610 and keys 608 are sent to the series of multiplication circuits 602 (e.g., 32-bit or 64-bit floating point multiplication units that are implemented in accordance with IEEE 754, which defines single-precision (32-bit) and double-precision (64-bit) representations). The outputs of multiplication circuits 602 are input to a cascade of adders 616 (e.g., floating point adders). The dimension M of vector Q can be a power 2^{x}, such that the number of layers of adders 616 is x. When index logic 604 selects the i^{th} row of keys 608, output 620 returns the i^{th} value of QK^{T}.

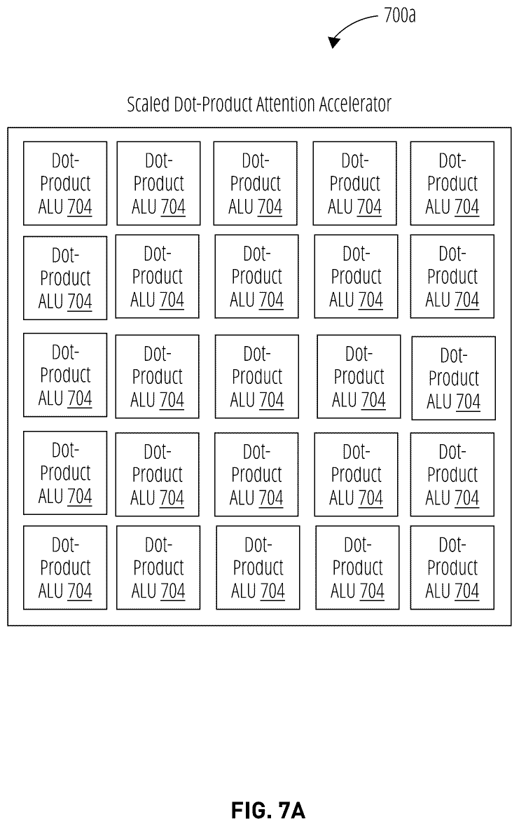

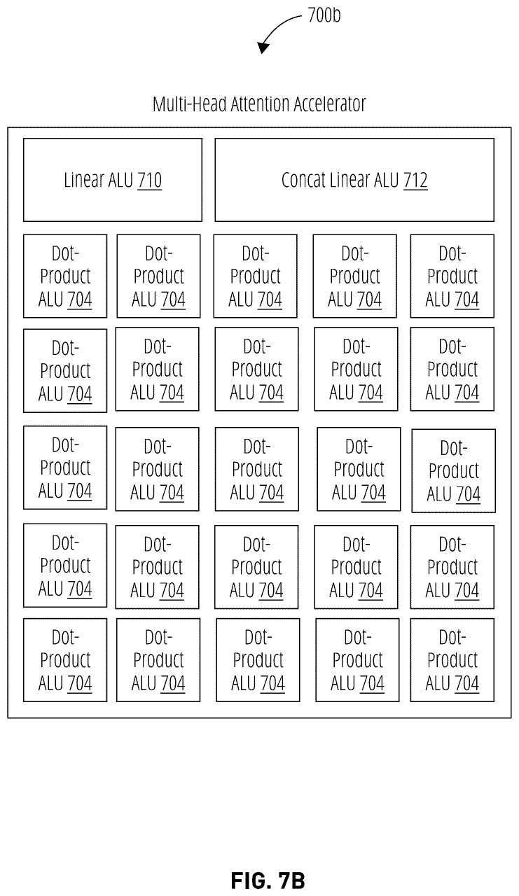

FIG. 7A illustrates an example of combining the scaled dot-product ALU 502 into a larger system of a multi-head attention accelerator (e.g., scaled dot-product attention accelerator 700a). Each of dot-product ALUs 704 can include one or more scaled dot-product ALU 502, and HBM stack 246 can be provided with a respective TSV connecting a stack of DRAM banks with a corresponding dot-product ALU 704.

For multi-head attention, a requester (e.g., a CPU, GPU, or higher-level accelerator) can perform the functions of linear block 402 of multi-head attention block 322 and send the outputs from linear block 402 to scaled dot-product attention accelerator 700a with instructions to perform the functions of scaled dot-product 404. Then, scaled dot-product attention accelerator 700a returns the scaled dot-product result to the request, which proceeds to perform the functions of concatenation block 406 and linear block 408 of multi-head attention block 322, which is illustrated in FIG. 4A.

FIG. 7B illustrates an example of combining the scaled dot-product ALU 502 into a larger system of a multi-head attention accelerator (e.g., multi-head attention accelerator 700b). Similar to FIG. 7A, each dot-product ALU 704 includes one or more scaled dot-product ALU 502, and HBM stack 246 can be provided with a respective TSV connecting a stack of DRAM banks with a corresponding dot-product ALU 704.

Additionally, in this case, the hardware accelerator (i.e., multi-head attention accelerator 700b) includes linear ALU 710 that is configured to perform the functions of linear block 402 of multi-head attention block 322, which is illustrated in FIG. 4A. Further, includes concat linear ALU 712 that is configured to perform the functions of concatenation block 406 and linear block 408 of multi-head attention block 322, which is illustrated in FIG. 4A.

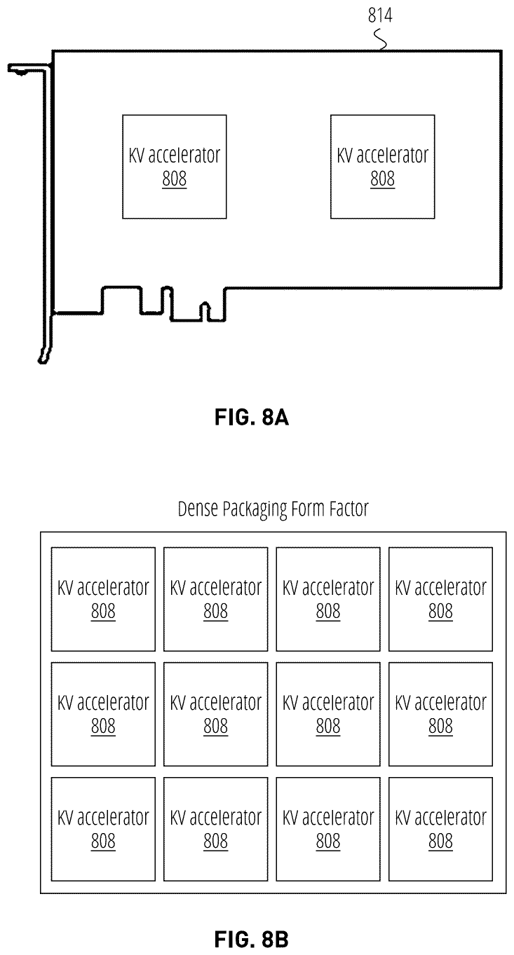

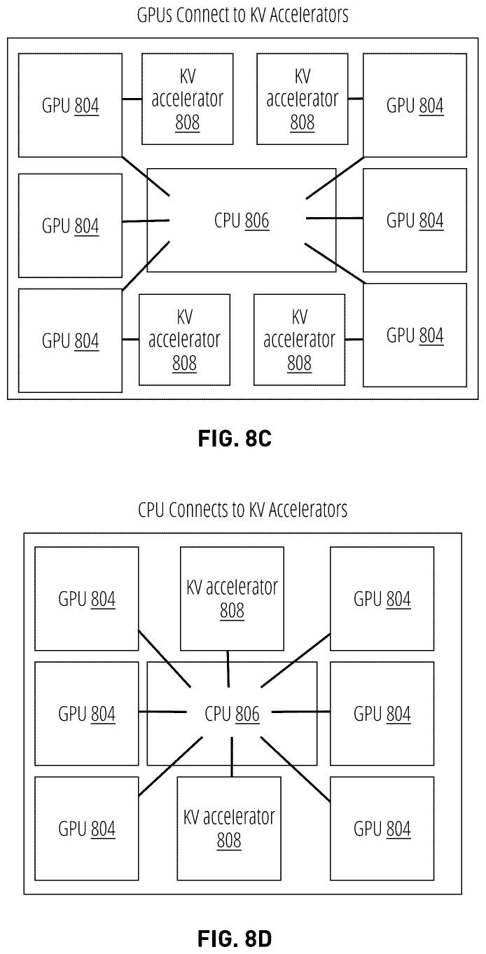

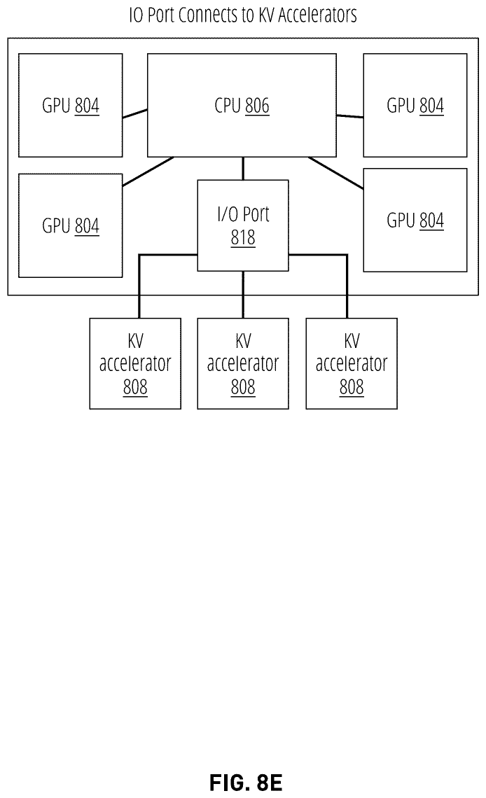

FIG. 8A and FIG. 8B illustrate various packaging options for the KV cache accelerator. Generally, the KV cache accelerator results in significant system-level benefits that result in a much-simplified form factor. While the internal bandwidth of the KV cache accelerator can be high, the communication bandwidth required for queries and results can be relatively low. For example, the relatively low requirements for the communication bandwidth between the KV cache accelerator and the request make it feasible for the KV cache accelerator to be assembled on simple PCIe card form factor or connection over Ethernet, as illustrated in FIG. 8A, where KV Accelerators 808 are configured on PCIe card 814, eliminating the need for advanced packaging and extreme system density.

FIG. 8B illustrates an example of KV Accelerator 808 being arranged in a dense packaging form factor. This configuration can be used, e.g., or less dense memory technologies such as SRAM, in order to fit enough memory to have entire user sequences within a package without incurring communication. Other options for packaging the KV cache accelerator can include, but are not limited to, packaging the KV cache accelerators on a common board; packaging the KV cache accelerators on a common Chip-on-Wafer-on-Substrate (CoWoS) substrate; packaging the KV cache accelerators on a common interposer; and wafer-scale integration.

FIG. 8C through FIG. 8E illustrate various connectivity options for the KV cache accelerator. In FIG. 8C, the KV Accelerators 808 are connected to GPUs 804, which are connected to CPU 806. For example, a KV accelerator 808 can be connected to the GPU either using a direction connection or through a PCIe switch.

In FIG. 8D, the KV Accelerators 808 are connected to CPU 806. For example, a KV accelerator 808 can be connected to the CPU 806 either using a direct connection or through a PCIe switch.

In FIG. 8E, the KV Accelerators 808 are connected to the main system (e.g., CPU 806 and GPUs 804) through an input/output (IO) port (e.g., IO port 818). IO port 818 provides a network connection for KV accelerators 808 that can be located on a separate machine. According to certain non-limiting examples, the network connection can be via Ethernet or Infiniband.

Thermal management is often a consideration for high-performance computing. According to certain non-limiting examples, in the KV cache accelerator, the majority of heat can be produced by the ALUs in processor die 204. Removing this heat through multiple layers of HBM DRAM dies can be challenging and operating the HBM at higher temperatures can degrade performance. When heat from the ALUs is conducted through the HBM DRAM dies, the thermal resistance of the HBM stack can be decreased by decreasing the number of layers (e.g., HBM DRAM dies) in the stack. Additionally or alternatively, hybrid bonding can be used rather than micro bumps between to provide improved thermal conductivity between layers (e.g., between HBM DRAM dies or between any of the dies and a substrate/interposer). The thermal management challenges can also be at least partially mitigated by using a memory technology that tolerates a higher temperatures. Further, as discussed below, thermal management challenges can also be at least partially mitigated by moving processor die 204 to the top of the HBM stack, e.g., closer to a heat sink.

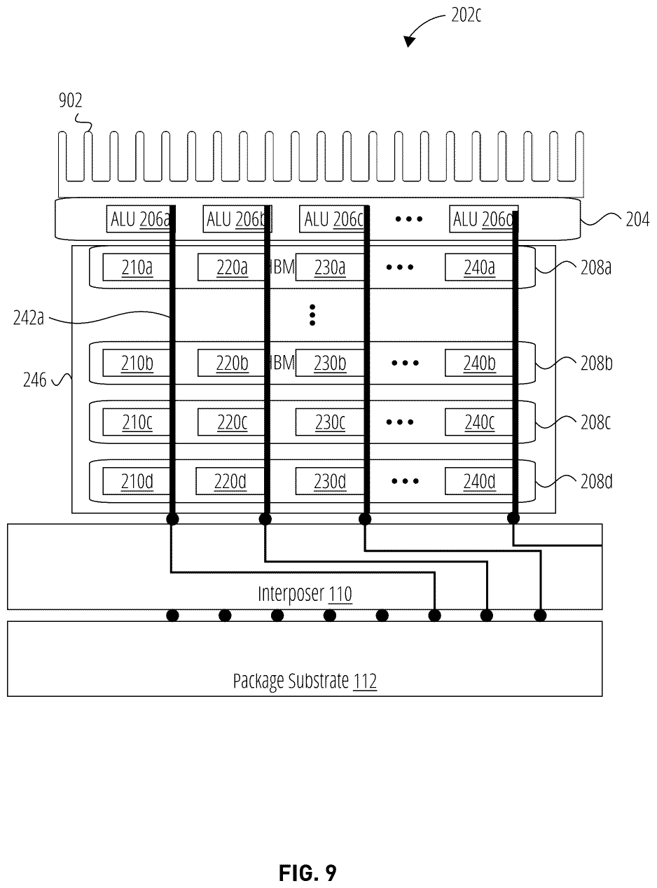

FIG. 9 illustrates a non-limiting example of system 202c that addresses thermal management challenges. Thermal management is often a consideration for high-performance computing. According to certain non-limiting examples, in the KV cache accelerator, the majority of heat can be produced by the ALUs in processor die 204. Removing this heat through multiple layers of HBM DRAM dies can be challenging and operating the HBM at higher temperatures can degrade performance.

System 202c provides improved thermal management by arranging processor die 204 on top of HBM stack 246 proximate to heat sink 902. The proximity between processor die 204 and heat sink 902 enables more efficient heat removal by avoiding heat transfer through the HBM, which has poor thermal transfer properties, in part, due to the space between the memory dies. Heat sink 902 transfers thermal energy from the heat-producing elements (e.g., processor die 204) to a lower-temperature fluid medium, such as air, water, or another fluid. For example, heat sink 902 can include a Peltier device connected to high thermal conductivity (e.g., metal) fins that are air-cooled. Additionally or alternatively, heat sink 902 can include a liquid- or air-cooled block with high thermal conductivity and high specific heat (e.g., metal) that contacts the packaging of processor die 204 via thermal conducting paste.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein can also be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

In some aspects, the techniques described herein relate to a computing system including: memory stacks, each of the memory stacks including memory banks fabricated on respective memory dies, the memory banks of a memory stack being electrically connected to each other; and arithmetic logic units configured on a processor die, the arithmetic logic units configured as a hardware accelerator for a predefined computational task; and wires connecting respective arithmetic logic units to associated memory stacks, such that for each of the arithmetic logic units, a wire connects a respective arithmetic logic unit to an associated memory stack of the memory stacks, wherein the wire extends from the respective arithmetic logic unit to the associated memory stack and a length of the wire is less than 2 mm.

In some aspects, the techniques described herein relate to a computing system, wherein an amount of memory included in the respective memory stacks matches an amount of data processed by the corresponding arithmetic logic units, such that, for each of the arithmetic logic units, an arithmetic logic unit processes data provided by a memory stack of the memory stacks that is closest to the arithmetic logic unit.

In some aspects, the techniques described herein relate to a computing system, wherein each of the memory stacks is paired with a corresponding arithmetic logic unit of the respective arithmetic logic units, and for each pair a maximum data read rate of a memory stack matches a maximum arithmetic throughput of the corresponding arithmetic logic unit.

In some aspects, the techniques described herein relate to a computing system, wherein the arithmetic logic units include respective caches and/or registers to store data next to arithmetic and/or logic circuits provided from processing the data to perform the computational task.

In some aspects, the techniques described herein relate to a computing system, wherein the predefined computational task has an average ratio of floating-point operations to used memory bandwidth that is less than 100.

In some aspects, the techniques described herein relate to a computing system, wherein: the memory dies are substantially parallel (substantially parallel means within 10 degrees of parallel) in a first direction and a second direction, for each of the memory stacks. The memory banks of a memory stack are stacked in a third direction, which is substantially perpendicular (substantially perpendicular means within 10 degrees of perpendicular) to the first direction and the second direction, the arithmetic logic unit connected to the memory stack overlaps with the memory stack in the first direction and the second direction, and the memory banks of the memory stack are connected to each other by a through silicon via.

In some aspects, the techniques described herein relate to a computing system, wherein: the memory banks are DRAM memory or SRAM memory, and the predefined computational task includes performing matrix multiplication using values stored on the memory stacks.

In some aspects, the techniques described herein relate to a computing system, wherein the length of the wire is less 0.5 mm.

In some aspects, the techniques described herein relate to a computing system, wherein the wire directly connects the arithmetic logic units to the memory stacks without passing through an interposer.

In some aspects, the techniques described herein relate to a computing system, wherein the processor die connects to another processor die through the interposer.

In some aspects, the techniques described herein relate to a computing system, further including other arithmetic logic units configured on the respective memory dies.

In some aspects, the techniques described herein relate to a computing system, wherein: the other arithmetic logic units are configured to perform another predefined computational task that has an average ratio of floating point operations to used memory bandwidth that is less than 100, and the predefined computational task for which the arithmetic logic units are configured has an average ratio of floating point operations to used memory bandwidth that is greater than 500.

In some aspects, the techniques described herein relate to a computing system, wherein the another predefined computational task includes performing matrix multiplications or vector multiplications using values stored on the memory stack.

In some aspects, the techniques described herein relate to a computing system, wherein the arithmetic logic units are configured as hardware accelerators for performing a dot-product based lookup algorithm.

In some aspects, the techniques described herein relate to a computing system, wherein the arithmetic logic units are configured as hardware accelerators for performing the dot-product based lookup algorithm for an attention mechanism in a transformer neural network.

In some aspects, the techniques described herein relate to a computing system, wherein: the memory stacks are between a package substrate and the processor die, and a heat-removal member is arranged on a side of the processor die opposite from memory stacks.

In some aspects, the techniques described herein relate to a computing system, wherein: the arithmetic logic units include dedicated circuits for performing floating-point multiplications and floating-point additions to accelerate a dot product between a query vector and a value matrix.

In some aspects, the techniques described herein relate to a computing system, wherein the arithmetic logic units include dedicated circuits for performing scaling operations and SoftMax operations.

In some aspects, the techniques described herein relate to a computing system, wherein, for each of the wires, a wire that connects a respective arithmetic logic unit to an associated memory stack is configured such that less than 0.2 pJ is needed to transfer a bit between the respective arithmetic logic unit and the associated memory stack.

In some aspects, the techniques described herein relate to a computing system, further including: one or more processors configured to perform a machine learning model that includes a dot-product based lookup step; and a hardware accelerator for performing the dot-product based lookup step, the hardware accelerator including the memory stacks arranged in a two-dimensional array and each of the memory stacks being paired with a corresponding arithmetic logic unit of the arithmetic logic units, such that each pair of a memory stack and an arithmetic logic unit includes an accelerator unit, and the accelerator units operate in parallel to perform the dot-product based lookup step.

In some aspects, the techniques described herein relate to a computing system, wherein: the machine learning model is a transformer model, and the dot-product based lookup step is part of an attention mechanism for the transformer model.

In some aspects, the techniques described herein relate to a computing system, wherein: the one or more processors include a central processing unit and/or a graphics processing unit, and the one or more processors are connected to a hardware accelerator using direct connection via peripheral component interconnect express (PCIe) or using a PCIe switch.

In some aspects, the techniques described herein relate to a computing system, wherein: the one or more processors include a central processing unit and/or a graphics processing unit, and the one or more processors are connected to a hardware accelerator using direct connection via a network connection.

What is claimed is:

1. A computing system comprising:
memory stacks, the memory stacks including memory banks fabricated on respective memory dies, the memory banks of a memory stack being electrically connected;
arithmetic logic units configured on a processor die, the arithmetic logic units configured as a hardware accelerator for a computational task; and
wires connecting respective arithmetic logic units to associated memory stacks, such that for the arithmetic logic units, a wire connects a respective arithmetic logic unit to an associated memory stack of the memory stacks, wherein
the wire extends from the respective arithmetic logic unit to the associated memory stack and a length of the wire is less than 2 mm.

2. The computing system of claim 1, wherein an amount of memory included in the respective memory stacks matches an amount of data processed by corresponding arithmetic logic units, such that, for each of the arithmetic logic units, an arithmetic logic unit processes data provided by a memory stack of the memory stacks that is closest to the arithmetic logic unit.

3. The computing system of claim 1, wherein each of the memory stacks is paired with a corresponding arithmetic logic unit of the respective arithmetic logic units, and for each pair a maximum data read rate of a memory stack matches a maximum arithmetic throughput of the corresponding arithmetic logic unit.

4. The computing system of claim 1, wherein:
the arithmetic logic units include respective caches and/or registers to store data next to arithmetic and/or logic circuits provided from processing the data to perform the computational task, and
the wire extending from the respective arithmetic logic unit to the associated memory stack comprises an electrical pathway that includes one or more metal-layer traces, one or more through-silicon vias, and passive and/or active circuitry that transmits bits between the respective arithmetic logic unit to the associated memory stack.

5. The computing system of claim 1, wherein the computational task has an average ratio of floating point operations to used memory bandwidth that is less than 100.

6. The computing system of claim 1, wherein:
the memory dies are substantially parallel in a first direction and a second direction,
for each of the memory stacks, the memory banks of a memory stack are stacked in a third direction, which is substantially perpendicular to the first direction and the second direction,
the arithmetic logic unit connected to the memory stack overlaps with the memory stack in the first direction and the second direction, and
the memory banks of the memory stack are connected to each other by a through silicon via.

7. The computing system of claim 1, wherein:
the memory banks are DRAM memory or SRAM memory, and
the computational task includes performing matrix multiplication using values stored on the memory stacks.

8. The computing system of claim 1, wherein the length of the wire is less 0.5 mm.

9. The computing system of claim 1, wherein the wire directly connects the arithmetic logic units to the memory stacks without passing through an interposer.

10. The computing system of claim 9, wherein the processor die connects to another processor die through the interposer.

11. The computing system of claim 1, further comprising:
other arithmetic logic units configured on the respective memory dies.

12. The computing system of claim 11, wherein:
the other arithmetic logic units are configured to perform another computational task that has an average ratio of floating point operations to used memory bandwidth that is less than 100, and
the computational task for which the arithmetic logic units are configured has the average ratio of the floating point operations to the used memory bandwidth that is greater than 500.

13. The computing system of claim 12, wherein the other computational task includes performing matrix multiplications or vector multiplications using values stored on the memory stack.

14. The computing system of claim 1, wherein the arithmetic logic units are configured as hardware accelerators for performing a dot-product based lookup algorithm.

15. The computing system of claim 14, wherein the arithmetic logic units are configured as the hardware accelerators for performing the dot-product based lookup algorithm for an attention mechanism in a transformer neural network.

16. The computing system of claim 1, wherein:
the memory stacks are between a package substrate and the processor die, and
a heat-removal member is arranged an a side of the processor die opposite from the memory stacks.

17. The computing system of claim 1, wherein:
the arithmetic logic units include dedicated circuits for performing floating point multiplications and floating point additions to accelerate a dot product between a query vector and a value matrix, and
the arithmetic logic units include other dedicated circuits for performing scaling operations and SoftMax operations.

18. The computing system of claim 1, wherein the wire that connects the respective arithmetic logic unit to the associated memory stack is configured such that less than 0.2 pJ is consumed when transferring a bit between the respective arithmetic logic unit and the associated memory stack.

19. The computing system of claim 1, further comprising:
one or more processors configured to perform a machine learning model that includes a dot-product based lookup step; and
a hardware accelerator for performing the dot-product based lookup step, the hardware accelerator including the memory stacks arranged in a two-dimensional array and each of the memory stacks being paired with a corresponding arithmetic logic unit of the arithmetic logic units, such that each pair of a memory stack and an arithmetic logic unit comprises an accelerator unit, and the accelerator units operate in parallel to perform the dot-product based lookup step.

20. The computing system of claim 19, wherein:
the machine learning model is a transformer model, and
the dot-product based lookup step is part of an attention mechanism for the transformer model.

21. The computing system of claim 19, wherein:
the one or more processors include a central processing unit and/or a graphics processing unit, and
the one or more processor are connected to the hardware accelerator using a network connection, a peripheral component interconnect express (PCIe) switch, or a PCIe direct connection.

22. The computing system of claim 1, wherein:
the hardware accelerator comprises the memory stacks arranged in a two-dimensional array and each of the memory stacks being paired with a corresponding arithmetic logic unit of the arithmetic logic units, and
the computing system comprises a plurality of hardware accelerators, which includes the hardware accelerator, and
the plurality of hardware accelerators are packaged according to a packaging configuration selected from the group consisting of: (1) packaging the plurality of hardware accelerators on a common board; (2) packaging the plurality of hardware accelerators on a common Chip-on-Wafer-on-Substrate; (3) packaging the plurality of hardware accelerators to connecting the plurality of hardware accelerators to each other via an interposer, and (4) wafer-scale integration of the plurality of hardware accelerators.
